(19) United States
(12) Patent Application Publication
(10) Pub. No.: US 2021/0260835 A1
(43) Pub. Date: Aug. 26, 2021

(54) HIGH SPEED VINYL WELDING AND CLEANING LINE OPERATION

(71) Applicant: Patrick Terence GRELLER, Westlake, OH (US)

(72) Inventor: Patrick Terence GRELLER, Westlake, OH (US)

(21) Appl. No.: 17/182,137

(22) Filed: Feb. 22, 2021

Related U.S. Application Data
(60) Provisional application No. 62/979,096, filed on Feb. 20, 2020.

(51) Int. Cl. B29C 65/74; B29C 65/02; B29C 65/00

(52) U.S. Cl. CPC B29C 65/745; B29C 66/87; B29C 65/02

(57) ABSTRACT

A manufacturing system for manufacturing rectangular frames of plastic material includes a horizontal frame welder configured to weld lengths of a plastic material together to form a rectangular frame. A corner cleaning station is configured to remove excess flash created in the welding process at the horizontal frame welder. A gantry is configured to automatically remove the rectangular frame from the horizontal frame welder after it is welded, move the rectangular frame to the corner cleaning station, and automatically place the rectangular frame in the corner cleaning station.

### CROSS REFERENCE TO RELATED APPLICATIONS

This application claims priority to U.S. Provisional Patent Application No. 62/979,096, filed on Feb. 20, 2020, entitled “HIGH SPEED VINYL WELDING AND CLEANING LINE OPERATION,” which is hereby incorporated by reference herein.

### BACKGROUND OF THE DISCLOSURE

### Field of the Disclosure

The present disclosure relates to manufacturing rectangular frames of plastic material, for example, vinyl casements, door frames, and window frames (e.g., sashes) and specifically relates to manufacturing apparatus and process steps relating to welding stations and cleaning stations.

### Discussion of Prior Art

In past disclosures, systems of machines for welding and cleaning vinyl sashes or frames have been provided. However, these known systems of machines faced a number of problems including, but not limited to, relatively slow output speeds, relatively large footprint areas, and relatively large operating personnel requirements, etc. As such, improvements are desired, and the present disclosure addresses at least some of these drawbacks of the prior disclosures.

### SUMMARY

This summary is provided to introduce concepts in a simplified form that are further described below in the detailed description. This summary is not intended to identify key factors or essential features of the claimed subject matter, nor is it intended to be used to limit the scope of the claimed subject matter.

In some embodiments, a manufacturing system for manufacturing rectangular frames of plastic material includes a horizontal frame welder configured to weld lengths of a plastic material together to form a rectangular frame. The manufacturing system also includes a corner cleaning station configured to remove excess flash created in the welding process at the horizontal frame welder. The manufacturing system further includes a gantry configured to automatically remove the rectangular frame from the horizontal frame welder after it is welded, move the rectangular frame to the corner cleaning station; and automatically place the rectangular frame in the corner cleaning station.

In some embodiments, a method of fabricating the corner of a plastic rectangular frame includes providing a horizontal frame welder for welding rectangular frames of plastic material. The method also includes loading a plurality of associated frame members into the horizontal frame welder. The method further includes welding the plurality of associated frame members to create the rectangular frames. The method still further includes providing a gantry apparatus for moving the rectangular frames. The method also includes using the gantry to automatically remove the rectangular frames from the horizontal frame welder. The method further includes moving the rectangular frames overhead. The method still further includes providing a corner cleaning station to remove excess flash from the rectangular frames. The method also includes using the gantry to automatically place the rectangular frames into the corner cleaning station.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a system of machines for welding and cleaning vinyl sashes or frames showing a gantry above a horizontal frame welder according to at least one embodiment of the present disclosure;

FIG. 2 is a perspective detail view of a horizontal frame welder of the system of machines of FIG. 1;

FIG. 3 is similar to FIG. 1, showing the gantry removing rectangular frames from the horizontal frame welder;

FIG. 4 is similar to FIG. 1 showing the gantry accumulating rectangular frames between the horizontal frame welder and a corner cleaning station;

FIG. 5 is similar to FIG. 1 showing the gantry placing a rectangular frame in the corner cleaning station;

FIG. 6 is a detail view of gripping devices associated with the gantry shown in FIG. 1;

FIG. 7 is a top-down flow chart representing method steps of operating the system of machines for manufacturing rectangular frames;

FIG. 8 is a first portion (of two) of a top-down flow chart representing method steps of operating the system of machines for manufacturing rectangular frames; and

FIG. 9 is a second portion (of two) of a top-down flow chart representing method steps of operating the system of machines for manufacturing rectangular frames.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

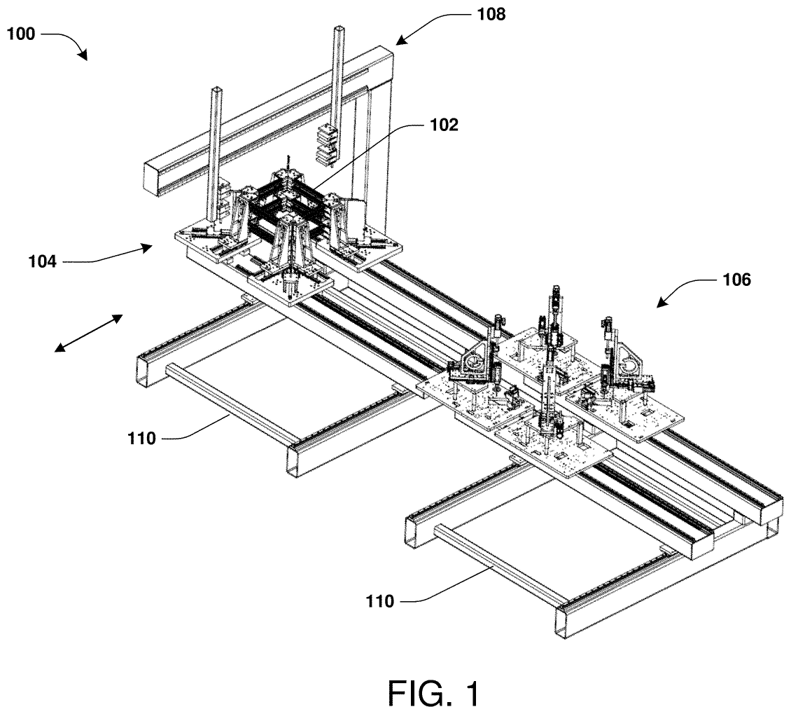

Referring to FIG. 1, a perspective view of a system of machines 100 for welding plastic rectangular frames 102 is illustrated. For the purposes of this disclosure, the term “plastic material” can include, but is not limited to, vinyl, polyvinyl chloride (PVC), polyurethane, ABS/ASA, cellular PVC, etc. At the left is a horizontal frame welder 104 that can weld four rectangular frames 102 (e.g., sashes) at a time. At the right is a corner cleaning station 106 configured to remove excess flash from the rectangular frame 102 after it is welded together. A gantry system 108 is shown above the horizontal frame welder 104 and the corner cleaning station 106.

As shown, the system of machines 100 can include a base framework 110. Each of the horizontal frame welder 104, the corner cleaning station 106, and the gantry system 108 can be mounted to the base framework 110. In some examples, the base framework 110 can enable movement of the entire system of machines 100 as a single unit, if necessary, while providing a rigid frame for the system of machines 100.

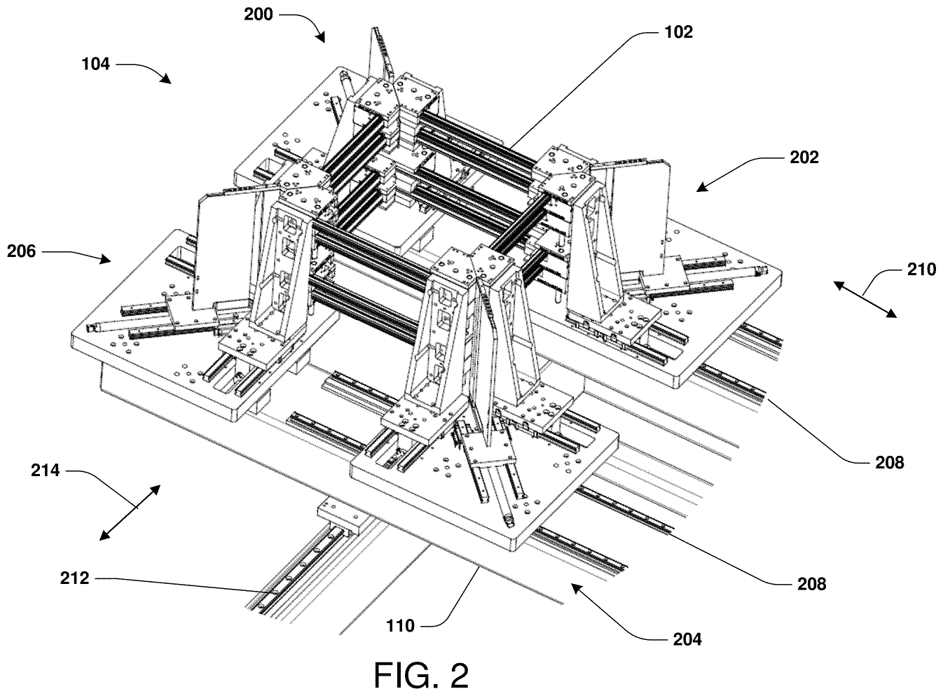

Referring to FIG. 2, an example horizontal frame welder 104 is illustrated. The horizontal frame welder 104 includes a plurality of welding heads 200, 202, 204, and 206. As in the shown example, there can be four welding heads 200, 202, 204, and 206 wherein one of the welding heads is stationary. For example, welding head 200 can be stationary and provide a known location which can serve as an origin for accurate coordinate measuring of lengths of associated frame components.

The horizontal frame welder 104 can include a plurality of motion devices (not shown) wherein a single motion device is connected to (e.g., mounted to) an individual welding head. For example, one motion device is mounted to each of the welding heads 202 and 204. Any suitable motion device is contemplated, but an example motion device is a servo motor. The servo motor can apply a force to selectively move (e.g., position) the welding head. In the illustrated example, two welding heads 202, 204 are supported by a slide or slides 208 attached to the base framework 110. The slide 208 can guide the welding heads 202, 204 as they are individually urged into motion by the motion devices. In the shown example, the motion devices can selectively translate welding heads 202, 204 toward and away from stationary welding head 200. In the figure, the described translation of “toward and away” for the combination of welding heads 202, 204 is generally represented in the upper left to lower right and lower right to upper left directions of FIG. 2 as represented by arrow 210.

Similarly, the welding heads 204, 206, can be supported by a slide or slides 212 attached to the base framework 110. The slide 212, can guide the welding heads 204, 206 as they are individually urged into motion by the motion device(s). In the shown example, the motion devices can selectively translate welding heads 204, 206 toward and away from stationary welding head 200. In the figure, the described translation of “toward and away” for the combination of welding heads 204, 206 is generally represented in the lower left to upper right and upper right to lower left directions of FIG. 2 as represented by arrow 214. As shown in FIG. 2, the stationary welding head 200 can be the welding head in the upper left corner of the horizontal frame welder 104, however, this is only an example, and the stationary welding head can be located at any of the other positions shown in FIG. 2.

A plurality of welding heads 200, 202, 204, 206 are mounted to the base framework 110 as previously described. More than one welding head (e.g., 202, 204, 206) of the plurality of welding heads 200, 202, 204, 206 is movable relative to the base framework 110 and more than one welding head 202, 204, 206 of the plurality of welding heads is movable relative to each of the other welding heads 200, 202, 204, 206. As previously described, this enables the stationary welding head 200 to provide a known location which can serve as an origin for accurate coordinate measuring of lengths of associated frame components used to create a rectangular frame 102. With this design, the horizontal frame welder 104 can accommodate a number of sizes (e.g., dimensions) of rectangular frames 102.

In some examples of systems of machines 100, the welded rectangular frames 102 are stacked during the welding process, in other words, the horizontal frame welder can accommodate multiple frames such that frame components can be welded into multiple rectangular frames 102 in one machine cycle. In some examples, the frame components are manually loaded into the horizontal frame welder by an operator. After welding, the rectangular frames 102 are unloaded from the horizontal frame welder 104 using an automated gantry 108 that first carries a bottom rectangular frame 102 (e.g., the lowest rectangular frame within the horizontal frame welder 104) away from the horizontal frame welder 104 (e.g., the rectangular frame is ejected to the gantry). The gantry 108 then takes the next lowest rectangular frame 102 and so on, until the horizontal frame welder 104 is devoid of finished rectangular frames 102 and is to be manually loaded for the following welding cycle.

In some previously known examples, the corner cleaner has two rectangular frames in process during a given welding cycle of operation. During the single cycle, the corner cleaner will clean the two trailing corners from a first rectangular frame and the two leading corners from the second rectangular frame. The corner cleaner then ejects the first rectangular frame and moves the second rectangular frame to the position previously occupied by the first rectangular frame to begin the cycle again with the second rectangular frame and a third rectangular frame.

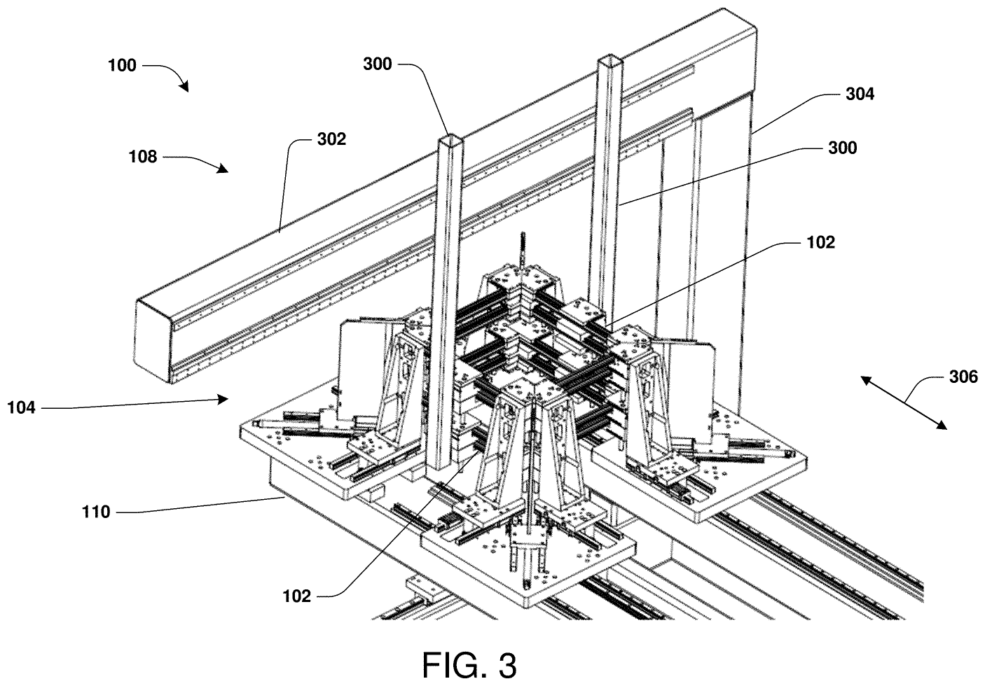

Referring to FIG. 3, a detail of the system of machines 100 is illustrated. In some examples, the system of machines 100 for welding rectangular frames 102 eliminates the need for a traditional accumulator conveyor or other conveyor system that otherwise occupies manufacturing floor space. Instead, the system of machines 100 utilizes the overhead gantry system 108 to accumulate rectangular frames 102. In traditional rectangular frame construction processes, a corner cleaning station having a slower cycle time than a welding station is a common occurrence. As such, work in process pieces can accumulate on the manufacturing floor or in accumulating conveyors or the like. However, in conjunction with the present disclosure, this floor accumulation of rectangular frames can be eliminated. For example, after a set of rectangular frames 102 is completed at the horizontal frame welder 104, the gantry 108 is configured to remove the welded rectangular frames 102. For the purposes of this disclosure, a set of rectangular frames 102 can include one, two, four, or any suitable number of rectangular frames. In the shown example of FIG. 3, the gantry 108 is in place to automatically remove four rectangular frames 102 from the horizontal frame welder 104.

Remaining with FIG. 3, the gantry 108 can include a vertical arm 300 extending from a cross arm 302 toward the horizontal frame welder 104. In some examples, there are multiple vertical arms 300. The cross arm 302 can be attached to a vertical post 304 that can traverse the base framework 110 in directions represented by arrow 306. While not shown, it is to be understood that the system of machines 100 can include a track configured to cooperate with the gantry, suitable motive force devices, etc. to properly control and guide the gantry 108 between a plurality of locations relative to the base framework 110.

The vertical arm 300 includes a gripping device 310 configured to cooperate with a portion of at least one rectangular frame 102. In some examples, the gripping device 310 can be aligned with an edge of a rectangular frame 102 where a portion of the gripping device 310 can be actuated to grip the rectangular frame 102 such that there is little or no relative motion between the rectangular frame 102 and the gripping device 310. In some examples, motion of the vertical arm 300 and/or the gantry 108 can effect rotation or translation of the gripping device 310 into a desired location to cooperate (e.g., grip) the rectangular frame 102 without requiring an actuated portion of the gripping device 310. Additionally, any suitable number of gripping devices 310 may be employed to grip the rectangular frame 102. When one or more rectangular frames are secured to the gripping device(s) 310, at least one of the gripping devices 310 or the vertical arm 300 can be moved in an upward direction (e.g., away from the horizontal frame welder 104). The gantry 108 then continues to move upward into the space above the horizontal frame welder 104 and the corner cleaning station 106) so that an operator can manually load the horizontal frame welder 104 with frame components for the next welding cycle.

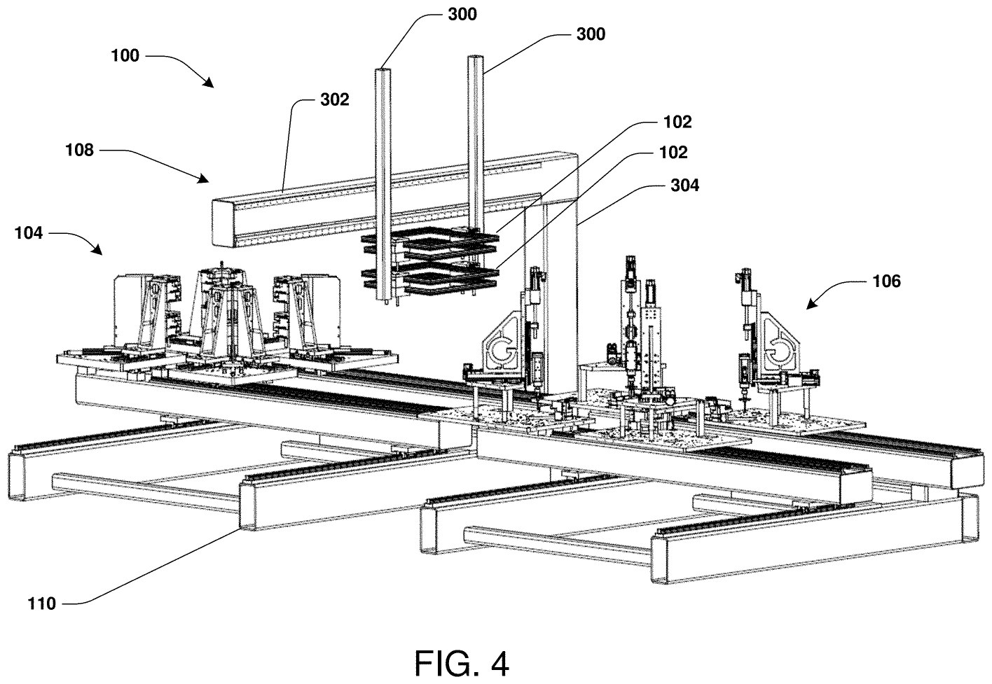

Referring to FIG. 4, the system of machines 100 is illustrated showing the gantry 108 accumulating rectangular frames 102 between the horizontal frame welder 104 and the corner cleaning station 106. After leaving the horizontal frame welder 104, the rectangular frames 102 are accumulated (e.g., held as work-in-process) in a space above the horizontal frame welder 104 and the corner cleaning station 106. Here, the rectangular frames 102 can remain in place until an automated interlock associated with the corner cleaning station 106 indicates that the gantry 108 can begin placing the rectangular frames 102 into the corner cleaning station 106. As noted previously, FIG. 4 shows four (4) rectangular frames 102 accumulated in the gantry 108, however other numbers of rectangular frames 102 are also contemplated.

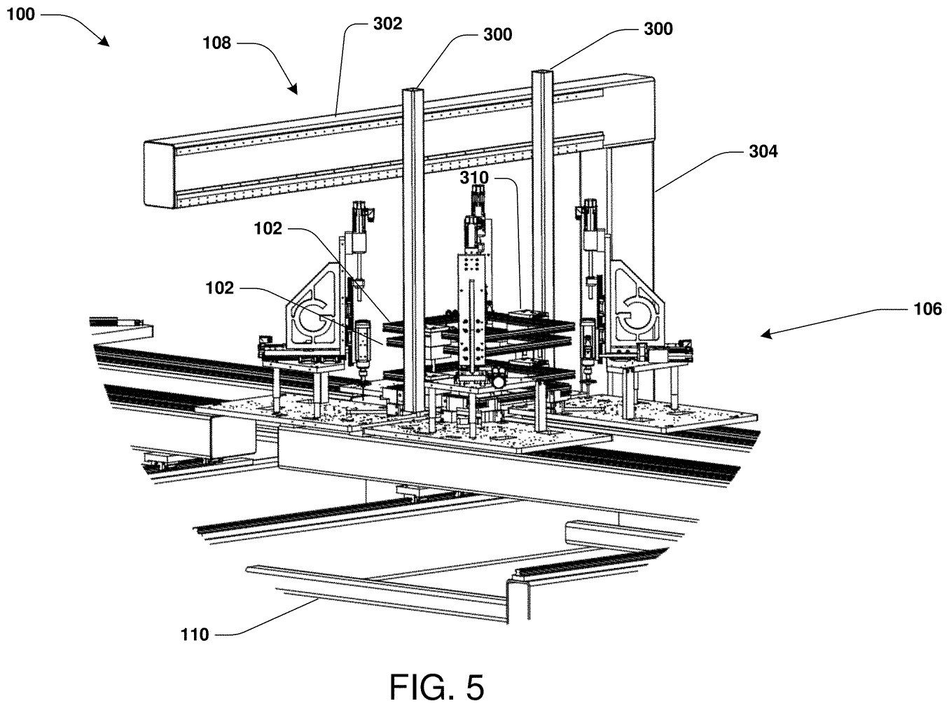

Referring to FIG. 5, the system of machines 100 is partially illustrated showing the gantry 108 having moved to the corner cleaning station 106. In some examples, the distance between the horizontal frame welder (not shown in FIG. 5) and the corner cleaning station 106 is about ten (10) feet. At least one of the vertical arm 300 or the gripping device 310 have been actuated in a downward direction to locate at least one rectangular frame 102 into the corner cleaning station 106. In some examples, the gantry 108 and its associated components can automatically place the rectangular frames 102 into the corner cleaning station 106. In other examples, an operator can manually remove the rectangular frames 102 from the gantry 108 and place the rectangular frames 102 into the corner cleaning station 106. In some examples, the rectangular frames 102 can be placed into the corner cleaning station 106 individually (e.g., one at a time). Obviously, certain benefits can be realized by including automated placement of the rectangular frames 102 into the corner cleaning station 106.

In these examples, it can be beneficial to have the corner cleaning station 106 have a cycle time for each rectangular frame 102 such that the sum of the cycle times of a particular number of rectangular frames 102 equals or is nearly equal to the cycle time to weld that particular number of rectangular frames 102 in the horizontal frame welder 104. In other words, it can be beneficial to design the cycle time for the horizontal frame welder 104 and the corner cleaning station 106 to be equal or nearly equal when processing the same number of rectangular frames. This can eliminate or help to eliminate production bottlenecks and increase speed of the production process.

In other examples, the total cycle time of the corner cleaning station 106 for a number of rectangular frame(s) 102 can be equal to or nearly equal to the cycle time of the horizontal frame welder 104 for the same number of rectangular frame(s) plus the time required to move the rectangular frame(s) 102 from the horizontal frame welder 104 to the corner cleaning station 106. For the purposes of this disclosure, the term nearly equal can mean within 15 seconds of each other. In further examples, the term nearly equal can mean within 10 seconds of each other. These time quantities can vary due to the proficiency of the operator and other causes. In the shown examples, the number of rectangular frames is four (4) such that the corner cleaning station 106 cycle time is equal to or nearly equal to one-fourth (¼) of the horizontal frame welder 104 cycle time. Of course, other numbers of rectangular frames 102 can be used and cycle times modified to satisfy the frame manufacturer's desire.

As the gantry 108 places a rectangular frame 102 into the corner cleaning station 106, the gripping devices 310 can undergo the reverse process described above to remove the rectangular frame 102 from the horizontal frame welder 104. In other words, when in position, the gripping devices 310 can have a portion that actuates to release the rectangular frame 102. In other examples, at least one of the vertical arms 300 and the gripping devices 310 can rotate or translate away from the rectangular frame 102 to place the rectangular frame 102 into the corner cleaning station 106. The corner cleaning station 106 can then complete a cycle to clean a single rectangular frame 102, after which, the gantry can place the next rectangular frame into the corner cleaning station 106.

At the completion of a corner cleaning cycle, the rectangular frames 102 can drop onto a discharge conveyor (not shown) below the corner cleaning station 106 (this can be an automated conveyor process). Then, the gantry 108 places the next rectangular frame 102 into the corner cleaning station 106.

The described arrangement enables removal of the accumulator system from rectangular frame manufacturing process as is common in many known manufacturing processes. In some examples, the overhead gantry 108 is the accumulator. In some examples, manufacturers can save up to forty linear feet of floor space and a significant area of floor space. The described system of machines 100 can also promote faster cycle times because the relatively slow-moving accumulating conveyors are eliminated. Instead, the relatively fast-moving gantry system is relied upon for the transfer of rectangular frames 102. Additionally, some opening and closing movements in the corner cleaning station 106 can be eliminated, further reducing cycle time.

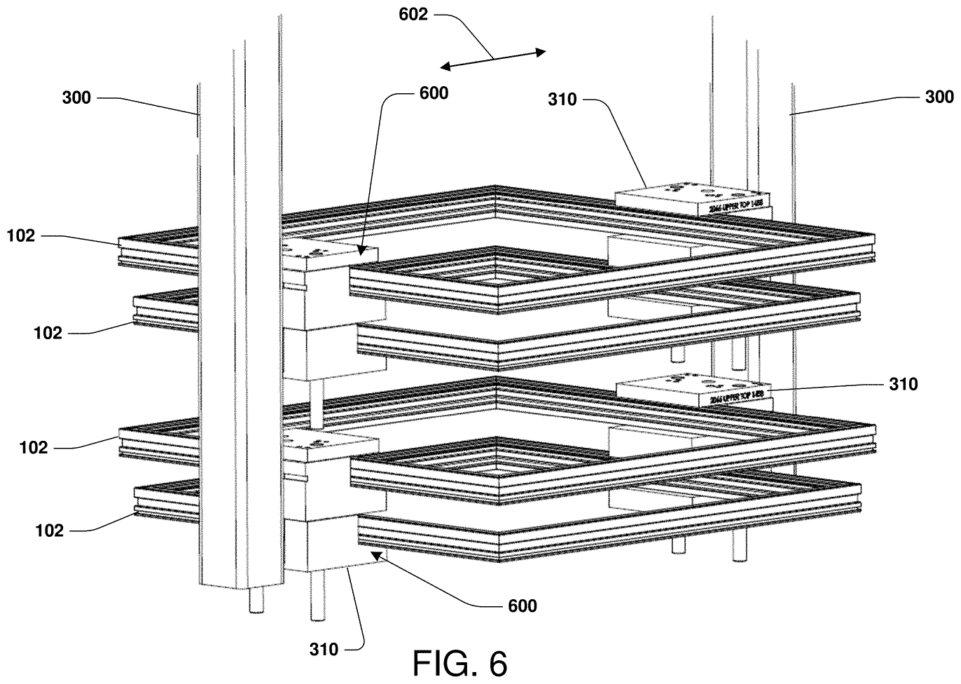

Referring to FIG. 6, a detail view of an example gripping device 310 arrangement is illustrated. As shown, four (4) gripping devices 310 can be used to grip the rectangular frames 102. In some examples, two (2) gripping devices 310 can be mounted to each vertical arm 300, although any suitable arrangement is satisfactory. In some examples, the gripping device 310 defines an opening 600 that is designed and engineered to cooperate with an edge of a rectangular frame 102. In such examples, the vertical arms 300 can be automatically controlled to locate the gripping devices 310 adjacent the rectangular frame 102 and then the vertical arm 300 can be translated toward the rectangular frame 102 in the direction of arrow 602 in order to engage (e.g, grip) the rectangular frame 102 for movement or further processing. As noted previously, this is meant to be but one example of a gripping device 310, and is not meant to be limiting.

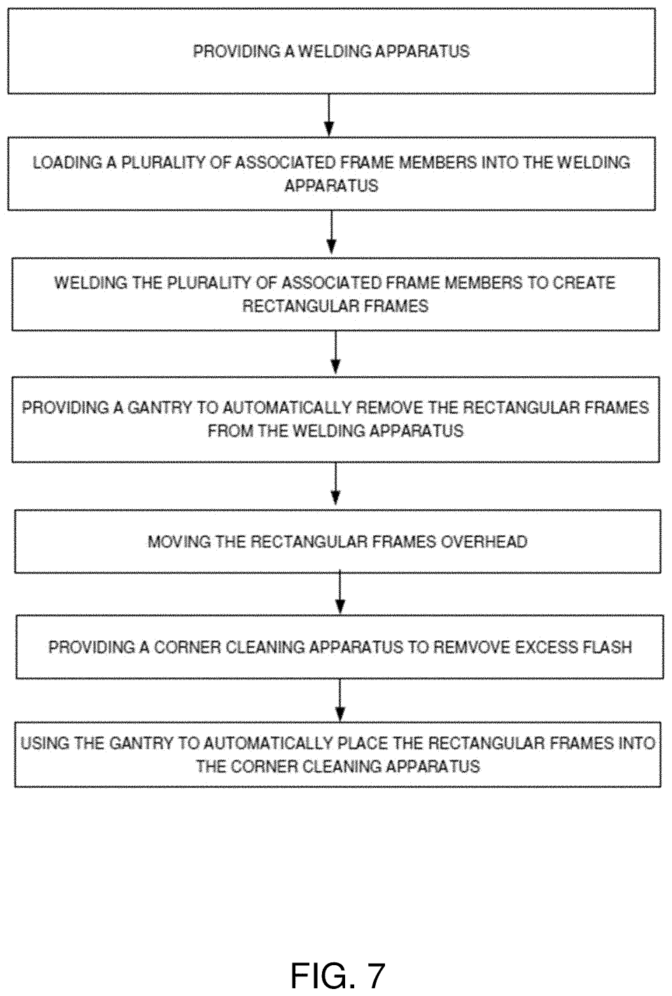

Referring to FIG. 7, a method for utilizing the described apparatus will now be discussed. The method includes providing a welding apparatus for welding rectangular frames of plastic material (e.g., vinyl). The method also includes loading a plurality of associated frame members into the welding apparatus. The welding apparatus then takes the action of welding the plurality of associated frame members to create the rectangular frames.

The method also includes providing a gantry apparatus for moving the rectangular frames. This can be in a space above the welding apparatus and the corner cleaning apparatus. Next, the method continues by using the gantry to automatically remove the rectangular frames from the welding apparatus and moving the rectangular frames overhead. The method further includes providing a corner cleaning apparatus to remove excess flash from the rectangular frames. Finally, the method includes using the gantry to automatically place the rectangular frames into the corner cleaning station.

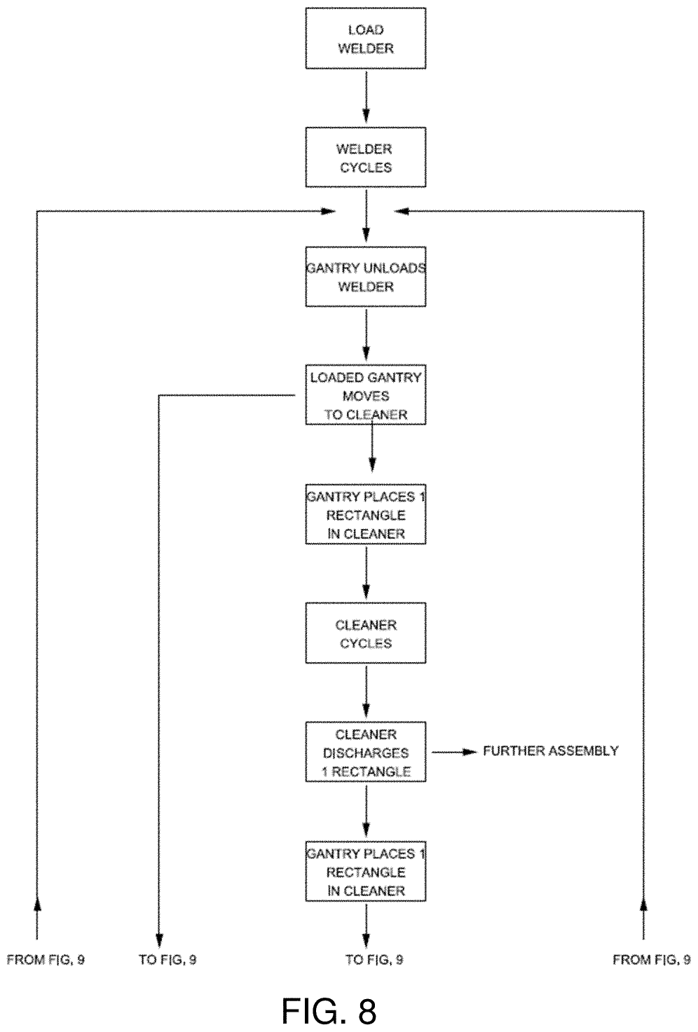

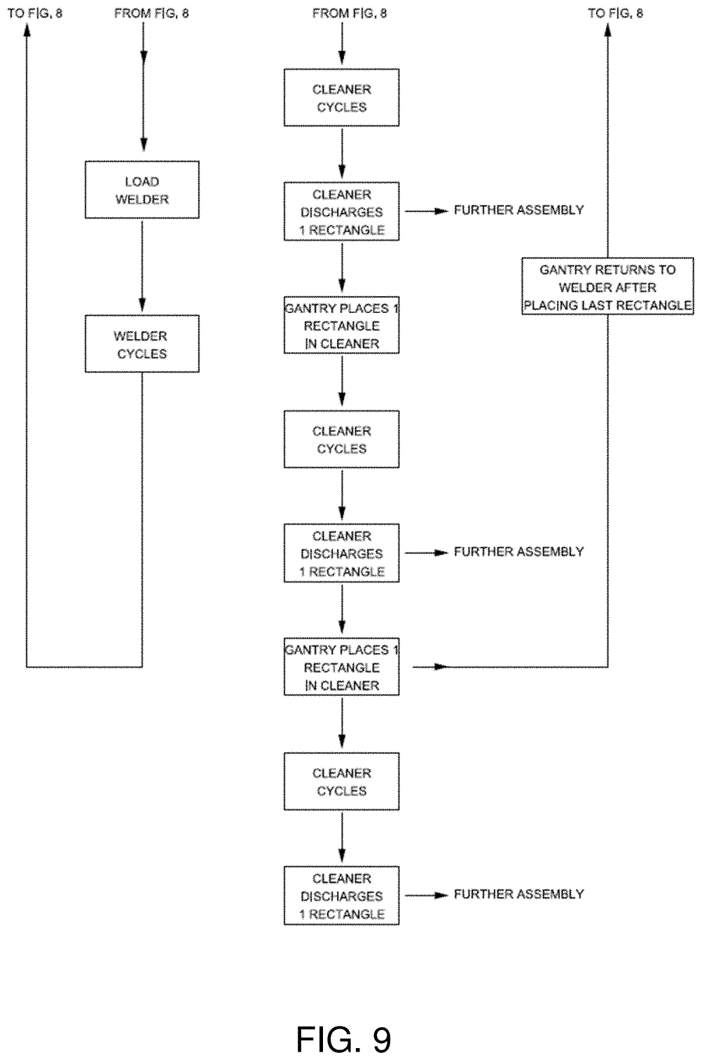

Referring to FIGS. 8 and 9, a method for utilizing the described apparatus will now be discussed. FIGS. 8 and 9 are divided for clarity, and are two parts of a single flow chart. In this flow chart, the term “rectangle” and the term rectangular frame 102 are used interchangeably. Additionally, the terms “welder” and “cleaner” are used interchangeably with the terms horizontal frame welder 104 and corner cleaning station 106, respectively.

As with many flow charts, this particular flow chart represents progression of time as the reader moves down the flow chart. Note that the flow chart has a central portion and portion on the left that graphically show the cycle timing of the horizontal frame welder and the corner cleaning station are equal or nearly equal in length. The method includes a load welder operation when an operator places frame components into the horizontal frame welder for welding. The welder then cycles to create at least one and perhaps multiple rectangular frames in one cycle of operation. The gantry then unloads the welder, moving the rectangular frames from the welder to the space above the welder and the cleaner for accumulation as work in process. The gantry then moves the rectangular frame(s) to the cleaner.

This paragraph includes method steps at the corner cleaning station that operate concurrently with some steps at the horizontal frame welder that are described in the very next paragraph. Concurrent operations involving gantry travel are described in the paragraph two below this paragraph. The gantry places one rectangle into the cleaner. The cleaner operates one cycle to remove extraneous material from the rectangle and then discharges the rectangle onto a conveyor. The gantry then places another (second) rectangle into the cleaner. The cleaner then operates one cycle to remove extraneous material from the second rectangle and then discharges the second rectangle onto a conveyor. The gantry then places another (third) rectangle into the cleaner. The cleaner then operates one cycle to remove extraneous material from the third rectangle and then discharges the third rectangle onto a conveyor. The gantry then places another (fourth) rectangle into the cleaner.

During the timed period of the method steps of the previous paragraph, between the gantry moving to the cleaner and the placement of the fourth rectangle into the cleaner, the welder is hand loaded with frame components and the welder operates one cycle. In some examples, one cycle of the welder welds multiple rectangles. The welder portion of the flow chart then returns to the method step of the gantry unloading the welder.

Additionally, when the gantry places the last rectangle (e.g., the fourth rectangle) into the cleaner, the gantry can return to the welder. The gantry returns to the welder prior to or at the same time as the welder cycle time is complete so that the gantry can remove the rectangles.

Finally, to return to the step of the fourth rectangle being placed in the cleaner, the cleaner then operates one cycle to remove extraneous material from the fourth rectangle and then discharges the fourth rectangle onto a conveyor. As with each of the previous rectangles, the conveyor takes the fourth rectangle to further assembly operations.

The described system of machines and associated methods can provide a number of benefits over known welder systems. For example, the described apparatus and methods can provide faster throughput than currently available welder systems. As such, the number of completed welded and cleaned frames per hour for the particular system can be increased. Further, the elimination of a transfer conveyor and/or accumulator conveyor between the welder and the cleaner can reduce the footprint of a typical vinyl welder system. Additionally, the manufacturing process can also reduce staffing needs in the manufacturing process, as an operator does not need to be dedicated to hand load the corner cleaning station. Each of these benefits can reduce the time and cost of manufacturing rectangular frames of various materials (e.g., plastic, vinyl, etc.).

The term “exemplary” may be used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first item and a second item may generally correspond to item A and item B or two different or two items or the same item.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular, regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A manufacturing system for manufacturing rectangular frames of plastic material, comprising:
a horizontal frame welder configured to weld lengths of a plastic material together to form a rectangular frame;
a corner cleaning station configured to remove excess flash created in a welding process at the horizontal frame welder;
a gantry configured to:
automatically remove the rectangular frame from the horizontal frame welder after it is welded;
move the rectangular frame to the corner cleaning station; and
automatically place the rectangular frame in the corner cleaning station.

2. The manufacturing system of claim 1, wherein the gantry uses space above the horizontal frame welder and the corner cleaning station in which to move the rectangular frame.

3. The manufacturing system of claim 1, wherein the gantry is configured to move a plurality of rectangular frames within a given operating cycle.

4. A method of fabricating a corner of a plastic rectangular frame, said method comprising:
providing a horizontal frame welder for welding rectangular frames of plastic material;
loading a plurality of associated frame members into the horizontal frame welder;
welding the plurality of associated frame members to create the rectangular frames;
providing a gantry for moving the rectangular frames;
using the gantry to automatically remove the rectangular frames from the horizontal frame welder;
moving the rectangular frames overhead;
providing a corner cleaning station to remove excess flash from the rectangular frames; and
using the gantry to automatically place the rectangular frames into the corner cleaning station.

5. The method of claim 4, wherein the rectangular frames are placed into the corner cleaning station one at a time.

6. The method of claim 4, wherein the rectangular frames are placed into the corner cleaning station one at a time and removed by hand operation one at a time as each rectangular frame has undergone a complete cleaning cycle.

7. The method of claim 4, wherein the gantry accumulates rectangular frames such that the gantry can accumulate a plurality of rectangular frames as work in process prior to placing the rectangular frames into the corner cleaning station.

8. The method of claim 7, wherein the gantry accumulates rectangular frames and using a space above the horizontal frame welder and the corner cleaning station.

9. The method of claim 4, wherein the horizontal frame welder welds four (4) rectangular frames in one cycle of operation.
